(19) United States
(12) Patent Application Publication
(10) Pub. No.: US 2016/0353529 A1
(43) Pub. Date: Dec. 1, 2016

(54) MICROWAVE PROCESSING APPARATUS

(71) Applicant: PANASONIC INTELLECTUAL PROPERTY MANAGEMENT CO., LTD., Osaka (JP)

(72) Inventors: YOSHIHARU OMORI, Shiga (JP); KOJI YOSHINO, Shiga (JP); MASAHARU TSUJIMOTO, Shiga (JP); TAKAHIDE YAMAGUCHI, Shiga (JP); JUNJI HIRATA, Shiga (JP); TAKAYUKI AKASHI, Nara (JP); MASAFUMI SADAHIRA, Shiga (JP); MASAYUKI KUBO, Shiga (JP)

(73) Assignee: Panasonic Intellectual Property Management Co., Ltd., Osaka (JP)

(21) Appl. No.: 15/117,688

(22) PCT Filed: Mar. 11, 2015
(86) PCT No.: PCT/JP2015/001325

§ 371 Date: Aug. 9, 2016

(30) Foreign Application Priority Data
Mar. 25, 2014 (JP) 2014-061329
Jan. 23, 2015 (JP) 2015-011260

(51) Int. Cl. H05B 6/70; H05B 6/64

(52) U.S. Cl. CPC H05B 6/708; H05B 6/6411; H05B 6/704

(57) ABSTRACT

Microwave oven (20) includes waveguide (3) having an E-bend structure, and multiple openings (4a, 4b). Waveguide (3) has first section (3a) for propagating a microwave from magnetron (2) toward heating chamber (1), and second section (3b) of which wide plane abuts on the outer wall of heating chamber (1). Multiple openings (4a, 4b) are disposed on a lateral face of heating chamber (1). Openings (4a, 4b) allow waveguide (3) to communicate with heating chamber (1), and include at least one circularly-polarized-wave opening (4a) for generating a circularly polarized wave. A cross section of first section (3a) orthogonally intersecting tube axis (7a) of first section (3a) is projected virtually along tube axis (7a) of first section (3a) onto a lateral face of heating chamber (1), and circularly-polarized-wave opening (4a) is formed such that its center is located outside the resultant projected region defined by this projection. The foregoing structure allows this compact size waveguide to generate a circularly polarized wave more positively.

### TECHNICAL FIELD

The present disclosure relates to a microwave processing apparatus (e.g. microwave oven) for heating a target object with a microwave.

### BACKGROUND ART

A microwave processing apparatus heats a target object (e.g. food) placed in a heating chamber with a microwave that is generated by a magnetron (i.e. a typical microwave generator) and then supplied to the heating chamber through a waveguide.

Nevertheless an electric field distribution generated in the heating chamber by the microwave supplied is not always uniform. A conventional apparatus uses a motor for rotating a turntable so that a target object can rotate within a heating chamber in order to be heated uniformly. Here is another conventional apparatus that employs a motor for rotating a rotary antenna, thereby agitating the microwave before the microwave is supplied into a heating chamber in order to heat a target object uniformly.

On the other hand, a method for uniformly heating a target object is proposed. This method uses a circularly polarized wave or an elliptically polarized wave, of which polarization plane rotates with the lapse of time. Generation of the circularly polarized wave or the elliptically polarized wave needs a pair of exciting means, of which exciting directions cross each other, for generating a pair of excitations where a phase difference is formed.

FIG. 12 shows an electric current running on a plane of a waveguide in the conventional microwave processing apparatus. As FIG. 12 shows, rectangular waveguide 100, through which a microwave propagates in TE10 mode, has a cross section that intersects with the longer direction (i.e. the propagating direction of the microwave) at right angles. This cross section forms a rectangle. Wave guide 100 includes narrow plane 102 and wide plane 103.

In such waveguide 100, in the case of forming an opening in cross section 101 vertical to the propagating direction of the microwave, electric field 104 is generated along the same direction within waveguide 100, so that excitation in uniaxial direction is generated. In the case of forming the opening in narrow plane 102, electric current 105 flows along the same direction in narrow plane 102, so that excitation in a uniaxial direction is generated.

Nevertheless, in the case of forming the opening in wide plane 103, electric current 105 flows in various directions depending on a place in wide plane 103, so that excitation in biaxial directions is generated.

Based on the foregoing reason, the opening should be formed in wide plane 103 in order to generate a circularly polarized wave, which is generated by a pair of exciting means of which exciting directions cross each other.

Propagation of the microwave causes an exciting position to move with a lapse of time, so that, for instance, two openings are formed in combination with each other for generating the circularly polarized wave.

FIG. 13A and FIG. 13B schematically illustrate changes in status of generating the circularly polarized wave at opening 107. Opening 107 is shaped like a cross-slot (i.e. two rectangular slots cross each other at right angles) for generating the circularly polarized wave.

FIG. 13A and FIG. 13B show propagating direction 109 of the microwave and a rotating direction of the circularly polarized wave generated at opening 107. FIG. 13A shows the propagating direction of the microwave from the top of the paper toward the bottom of the paper, and, contrary to FIG. 13A, FIG. 13B shows the propagating direction of the microwave from the bottom of the paper toward the top of the paper.

In FIG. 13A, propagating direction 109 in waveguide 100 is directed downward of the paper. Magnetic field 108 generated by the microwave moves downward with a lapse of time.

As FIG. 13A shows, at time to, magnetic field 108 excites a first rectangular slot of opening 107 in exciting direction 110a. At time t1, namely, after a lapse of a given time, magnetic field 108 moves downward, and a second slot of opening 107 is excited in exciting direction 110b. At time t2 and time t3, exciting directions 110c and 110d are changed in turn as illustrated in FIG. 13A, so that the circularly polarized wave that rotates anti-clockwise is generated.

As FIG. 13B shows, propagating direction 109 within waveguide 100 is directed upward on the paper. Magnetic field 108 generated by the microwave moves upward on the paper with a lapse of time. A time lapse from time TO to time t3 causes exciting directions 110a, 110b, 110c, and 110d at opening 107 to change as shown in FIG. 13B, so that the circularly polarized wave that rotates clockwise, which is reversal to what is shown in FIG. 13A, is generated. As discussed above, the circularly polarized wave or the wave rotating in a reversal direction is generated in response to propagating direction 109 within waveguide 100.

FIG. 14 is a schematic plan view of a waveguide, which generates a circularly polarized wave, of a conventional microwave processing apparatus disclosed in patent literature 1. FIG. 15 is a schematic perspective view of a waveguide, which generates a circularly polarized wave, of another conventional microwave processing apparatus disclosed in patent literature 2.

As FIG. 14 shows, patent literature 1 discloses a structure in which opening 107 is disposed on waveguide 106a. This opening is formed of two rectangular slots crossing each other vertically. As FIG. 15 shows, patent literature 2 discloses a structure in which openings 107a and 107b are disposed in a wide plane of waveguide 106b. These openings 107a and 107b do not cross each other, but disposed vertically to each other.

### CITATION LIST

Patent Literature 1: U.S. Pat. No. 4,301,347
Patent Literature 2: Examined Japanese Patent Publication No. 3510523

### SUMMARY OF INVENTION

The prior art disclosed in patent literatures 1 and 2 need to make waveguides 106a and 106b longer in order to avoid adverse influences such as disturbance in electromagnetic filed distribution around a magnetron.

Reflected waves generated at the ends of waveguides 106a and 106b allow generating circularly polarized waves rotating in a reversal direction, so that the rotation in an exciting direction can be cancelled, or a generation of standing waves in waveguides 106a and 106b lowers a radiation efficiency from the opening.

As FIG. 14 shows, the conventional art disclosed in patent literature 1 includes phase shifter 111 (i.e. rotating body) at the end of waveguide 106a in order to change a phase of the reflected wave. Nevertheless, this prior art is silent about an advantage of reducing the reflected wave, but it describes that waveguide 106a is obliged to be substantially longer.

The present disclosure addresses the foregoing problems, and aims to provide a microwave processing apparatus capable of generating efficiently a circularly polarized wave or an elliptically polarized wave by using a compact wave guide.

To solve the foregoing problems, the microwave processing apparatus in accordance with one aspect of the present disclosure includes a heating chamber for accommodating a target object, a microwave generator, a waveguide, and multiple openings.

The waveguide has an E-bend structure, a first section for propagating a microwave from the microwave generator toward the heating chamber, and a second section of which wide plane abuts on the outer wall of the heating chamber. The multiple openings are formed on a lateral face of the heating chamber. The openings allow the heating chamber to communicate with the waveguide. The multiple openings include at least one circularly-polarized-wave opening for generating a circularly polarized wave.

A cross section of the first section orthogonally intersecting a tube axis of the first section is projected virtually, along the tube axis of the first section, onto a lateral face of the heating chamber, and the circularly-polarized-wave opening is formed such that its center is not located in the resultant projected region defined by this projection.

The foregoing structure of this aspect allows reducing adverse effects (e.g. disturbance in the electromagnetic field distribution around the magnetron). As a result, use of the compact size waveguide allows generating a circularly polarized wave or an elliptically polarized wave more positively.

### BRIEF DESCRIPTION OF DRAWINGS

FIG. 1 is a sectional view of a microwave processing apparatus in accordance with a first embodiment of the present disclosure.

FIG. 2 shows schematically an opening, which allows a heating chamber to communicate with a waveguide of the microwave processing apparatus in accordance with the first embodiment.

FIG. 3 is an enlarged sectional view of the microwave processing apparatus in accordance with the first embodiment.

FIG. 4A shows an example of an opening that allows a waveguide to communicate with a heating chamber in accordance with a second embodiment of the present disclosure.

FIG. 4B shows an example of an opening in accordance with the second embodiment.

FIG. 4C shows an example of an opening in accordance with the second embodiment.

FIG. 4D shows an example of an opening in accordance with the second embodiment.

FIG. 5A shows an example of an opening that allows a waveguide to communicate with a heating chamber in accordance with a third embodiment of the present disclosure.

FIG. 5B shows an example of an opening in accordance with the third embodiment.

FIG. 5C shows an example of an opening in accordance with the third embodiment.

FIG. 6A shows an example of an opening that allows a waveguide to communicate with a heating chamber in accordance with a fourth embodiment of the present disclosure.

FIG. 6B shows an example of an opening in accordance with the fourth embodiment.

FIG. 6C shows an example of an opening in accordance with the fourth embodiment.

FIG. 6D shows an example of an opening in accordance with the fourth embodiment.

FIG. 6E shows an example of an opening in accordance with the fourth embodiment.

FIG. 6F shows an example of an opening in accordance with the fourth embodiment.

FIG. 6G shows an example of an opening in accordance with the fourth embodiment.

FIG. 6H shows an example of an opening in accordance with the fourth embodiment.

FIG. 6I shows an example of an opening in accordance with the fourth embodiment.

FIG. 7 shows an opening that allows a waveguide to communicate with a heating chamber in accordance with a fifth embodiment of the present disclosure.

FIG. 8A shows an opening that allows a waveguide to communicate with a heating chamber in accordance with a sixth embodiment of the present disclosure.

FIG. 8B shows an opening that allows a waveguide to communicate with a heating chamber in accordance with the sixth embodiment of the present disclosure.

FIG. 9 shows changes in status of generating a circularly polarized wave in accordance with the sixth embodiment.

FIG. 10 shows an opening that allows a waveguide to communicate with a heating chamber in accordance with a seventh embodiment of the present disclosure.

FIG. 11A shows a directivity of a slot opening provided to a waveguide.

FIG. 11B shows a directivity of a circularly-polarized-wave opening provided to a waveguide in accordance with an eighth embodiment of the present disclosure.

FIG. 11C shows a directivity of a circularly-polarized-wave opening provided to a waveguide in accordance with the eighth embodiment of the present disclosure.

FIG. 12 shows electric currents flowing on a lateral face of a waveguide of a conventional microwave processing apparatus.

FIG. 13A shows a change in status in which a circularly polarized wave is generated at a cross-slot shaped opening.

FIG. 13B shows a change in status in which the circularly polarized wave is generated at the cross-slot shaped opening.

FIG. 14 is a schematic plan view of a waveguide that generates a circularly polarized wave in the conventional microwave processing apparatus.

FIG. 15 is a schematic perspective view of the waveguide that generates a circularly polarized wave in the conventional microwave processing apparatus.

### DESCRIPTION OF EMBODIMENTS

A microwave processing apparatus in accordance with a first aspect of the present disclosure includes a heating chamber for accommodating a target object, a microwave generator, a waveguide, and multiple openings.

The waveguide has an E-bend structure, a first section for propagating a microwave from the microwave generator toward the heating chamber, and a second section of which wide plane abuts on the outer wall of the heating chamber. The multiple openings are formed on a lateral face of the heating chamber. The openings allow the heating chamber to communicate with the waveguide. The multiple openings include at least one circularly-polarized-wave opening for generating a circularly polarized wave.

A cross section of the first section orthogonally intersecting a tube axis of the first section is projected virtually, along the tube axis of the first section, onto a lateral face of the heating chamber, and the circularly-polarized-wave opening is formed such that its center is not located in the resultant projected region defined by this projection.

A microwave processing apparatus in accordance with a second aspect of the present disclosure includes a reflected-wave-suppression opening in addition to the structural elements of the microwave processing apparatus in accordance with the first aspect. The reflected-wave-suppression opening is disposed closer to the end of the waveguide than the circularly-polarized-wave opening, and has a length equal to or greater than a half of the wavelength of the microwave. According to this second aspect, a compact size waveguide that allows reducing reflected waves generated at the end of the waveguide can be formed.

A microwave processing apparatus in accordance with a third aspect of the present disclosure includes a table at a lower section of the heating chamber and a driver for rotating the table in addition to the structural elements of the apparatus in accordance with the second aspect. The reflected-wave-suppression opening is located at the lower section of the heating chamber.

According to the third aspect, a rotation of the target object allows changing an amount and a phase of the reflected wave traveling from the heating chamber into the waveguide. In response to these changes, an amplitude and a position of the standing wave generated in the waveguide change. As a result, the target object can be heated more uniformly.

A microwave processing apparatus in accordance with a fourth aspect of the present disclosure includes a structure of the circularly-polarized-wave opening where two slot-openings are combined. This structure differs from that of the first aspect. According to this fourth aspect, excitations in two directions are generated, thereby generating the circularly polarized wave more positively.

A microwave processing apparatus in accordance with a fifth aspect of the present disclosure includes a structure in which the circularly-polarized-wave opening is formed such that the center of the circularly-polarized-wave opening deviates from a tube axis of the second section. This structure differs from that of the first aspect. According to the fifth aspect, the waveguide is excited at the edge of the magnetic field propagating, thereby generating the circularly polarized wave more positively.

A microwave processing apparatus in accordance with a sixth aspect of the present disclosure includes a structure in which the circularly-polarized-wave opening shapes like a regular polygon or a circle. This structure differs from that of the first aspect. According to the sixth aspect, the waveguide is excited at the edge of the magnetic field propagating, thereby exciting the microwave, supplied into the heating chamber, in two directions uniformly. As a result, the circularly polarized wave can be generated more positively.

A microwave processing apparatus in accordance with a seventh aspect of the present disclosure includes a structure in which the circularly-polarized-wave opening shapes like a polygon, and this polygonal opening has multiple and longest diagonal lines. This structure differs from that of the first aspect. According to the seventh aspect, this structure allows generating more positively the excitations in two directions different from each other, whereby the circularly polarized wave can be generated more positively.

A microwave processing apparatus in accordance with an eighth aspect of the present disclosure includes a structure in which the slot opening has a longer direction length different from a shorter direction length, and also includes rounded corners. The circularly-polarized-wave opening has multiple and longest inner diameters. These structures differ from those in the fourth aspect. According to this eighth aspect, directions of excitations generated at each slot can be stabilized, thereby stabilizing the excitations in two directions different from each other. As a result, the circularly polarized wave can be generated more positively.

A microwave processing apparatus in accordance with a ninth aspect of the present disclosure includes a structure in which the circularly-polarized-wave opening includes the slot-openings crossing each other at an angle other than 90 degrees. This is a different point from the structure of the fourth aspect. According to the ninth aspect, a directivity of the circularly polarized wave generated can be polarized in a desirable direction.

A microwave processing apparatus in accordance with a tenth aspect of the present disclosure includes a structure in which a first slot opening intersects with the tube axis of the waveguide at a first angle, and a second slot opening intersects with the tube axis of the waveguide at a second angle different from the first angle. This is a different point from the structure of the fourth aspect. According to the tenth aspect, a directivity of the circularly polarized wave generated can be polarized in a desirable direction.

Preferred embodiments of the microwave processing apparatuses in accordance with the present disclosure are demonstrated hereinafter with reference to the accompanying drawings. In the embodiments below, instances of the microwave oven are described; however, the microwave processing apparatus of the present disclosure is not limited to the microwave oven, but the apparatus includes a processing apparatus, garbage processor, or semiconductor manufacturing device using the heat by microwave.

In the following drawings, structural elements similar to each other have the same reference marks, and the descriptions thereof are sometimes omitted.

### First Exemplary Embodiment

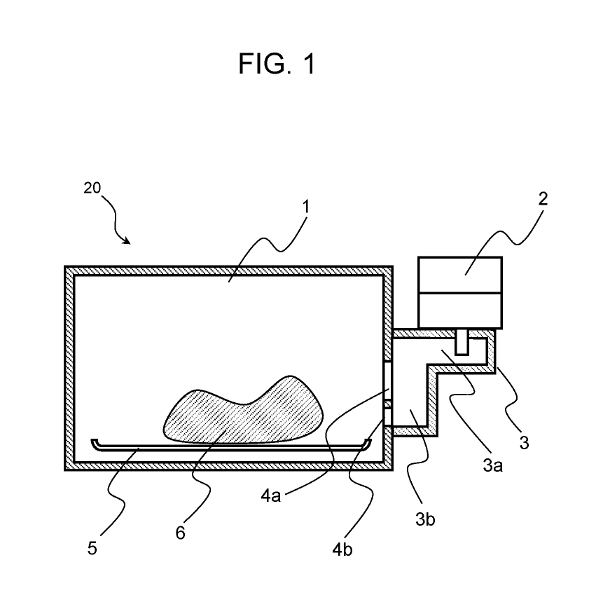

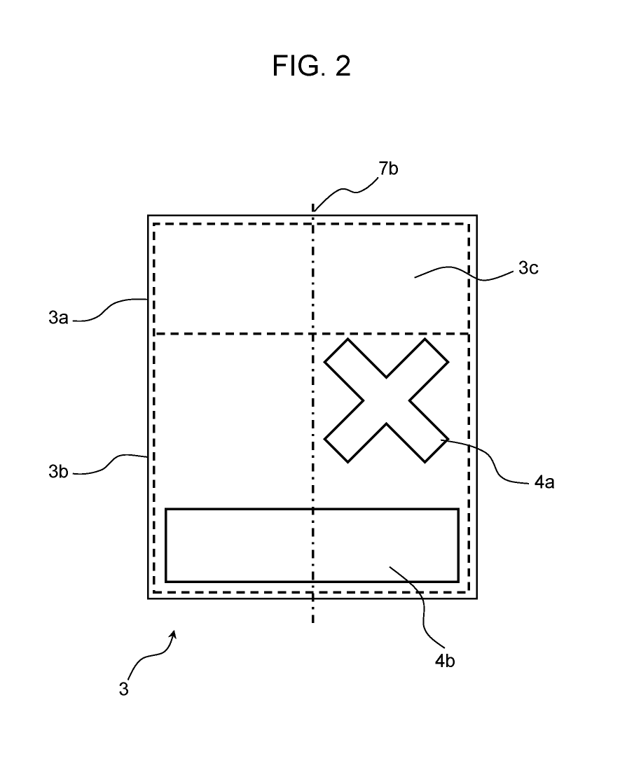

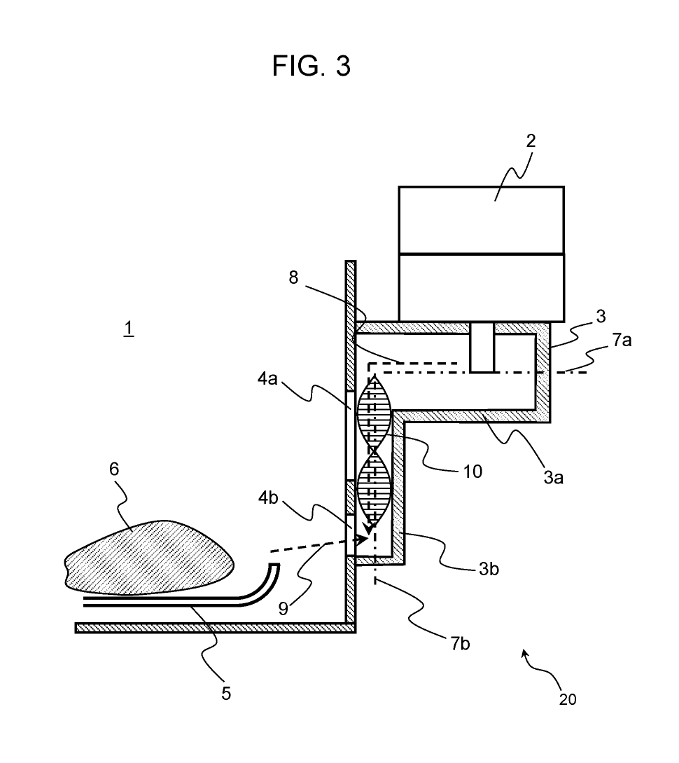

FIG. 1 is a schematic sectional view of microwave oven 20, namely, the microwave processing apparatus in accordance with the first embodiment. FIG. 1 specifically shows structures of waveguide 3 and heating chamber 1. FIG. 2 shows an opening that allows heating chamber 1 to communicate with waveguide 3. This FIG. 2 is viewed from the inside of heating chamber 1. FIG. 3 is an enlarged sectional view of waveguide 3 and its vicinity.

As FIG. 1-FIG. 3 show, microwave oven 20, which is an example of the microwave processing apparatus in accordance with the first embodiment, includes target object 6 placed on table 5 disposed in heating chamber 1. Magnetron 2 works as a microwave generator. Waveguide 3 is mounted to a lateral face of heating chamber 1 viewed from the front of chamber 1.

The microwave generated by magnetron 2 propagates through waveguide 3 and arrives at circularly-polarized-wave opening 4a disposed between heating chamber 1 and waveguide 3. When the microwave travels through opening 4a, the circularly polarized wave is generated at opening 4a. The microwave changed into the circularly polarized wave is supplied to target object 6 accommodated in heating chamber 1.

Reflected-wave-suppression opening 4b is formed closer to a lower end of waveguide 3 than opening 4a (in this embodiment, it is located below opening 4a), and allows waveguide 3 to communicate with heating chamber 1. Opening 4b shapes like a rectangle of which longer side is equal to or greater in length than a half of the wavelength of the microwave traveling through waveguide 3.

Waveguide 3 is a square waveguide and has a cross section that shapes like a rectangle and orthogonally intersects with the propagating direction of the microwave. This square waveguide 3 includes a pair of surfaces each having a greater width and referred to as a wide plane, and another pair of surfaces each having a smaller width and referred to as a narrow plane.

Waveguide 3 includes a first section and a second section in which the narrow plane is bent like a letter L and intersecting with each other substantially at right angles. This structure is generally referred to as an E-bend structure.

The first section extends substantially vertically to the lateral faces of heating chamber 1, and propagates the microwave toward heating chamber 1 (in FIG. 1 and FIG. 3, toward the left). The second section extends along the lateral faces of heating chamber 1 and propagates the microwave in parallel with the lateral faces of heating chamber 1 (in FIG. 1 and FIG. 3, toward the downward direction). The first section is referred to as vertical section 3a, and the second section is referred to as parallel section 3b hereinafter.

Waveguide 3 abuts on heating chamber 1 at the wide plane of parallel section 3b, and is located such that the lower end thereof is situated as high as table 5 in heating chamber 1.

The structure discussed above allows waveguide 3 to be accommodated within a space necessary for placing magnetron 2.

A propagation distance of the microwave in waveguide 3 is a total length of a length of vertical section 3a along the tube axis of waveguide 3 and a length of parallel section 3b. Heating chamber 1 of a low height thus can keep a sufficient propagation distance, which prevents the disturbance in the electromagnetic field generated around magnetron 2 from adversely influencing the vicinities of circularly-polarized-wave opening 4a and reflected-wave-suppression opening 4b.

As FIG. 2 shows, circularly-polarized-wave opening 4a forms a shape of a cross slot that shapes like a letter X in which two rectangular slots intersect orthogonally with each other. These two rectangular slots have the same dimensions and the same shape.

Circularly-polarized-wave opening 4a is formed in the following manner: A cross section of vertical section 3a orthogonally intersecting with tube axis 7a (refer to FIG. 3) of vertical section 3a is virtually projected along tube axis 7a onto a lateral face of heating chamber 1. The resultant region defined by this projection and formed on the lateral face of heating chamber 1 is hereinafter referred to as cross-section projected region 3c. Circularly-polarized-wave opening 4a is formed such that the center of opening 4a should be located outside this region 3c.

On top of that, circularly-polarized-wave opening 4a is formed such that the center of opening 4a should be located outside tube axis 7b of parallel section 3b shown in FIG. 2. Tube axis 7b, to be more specific, is a straight line projected on the wide plane of parallel section 3b, and yet, is a center line of a shorter side of parallel section 3b of wave guide 3.

The foregoing location of circularly-polarized-wave opening 4a allows generating an excitation at the edge of the electromagnetic field having less disturbances, and this excitation has a time lag in two directions. As a result, the structure discussed above allows generating a circularly polarized wave or an elliptically polarized wave more positively.

Almost all the microwave propagating to the end of waveguide 3 is supplied, through reflected-wave suppression opening 4b, into heating chamber 1 as linearly polarized microwave. Since opening 4b can suppress the reflection of the microwave at the end of waveguide 3, the circularly polarized wave or the elliptically polarized wave can be generated more positively at opening 4a.

Target object 6 is placed on table 5 to be rotated by a motor (driver, not shown), so that it can rotate in heating chamber 1. The rotation of target object 6 causes a distance between target object 6 and reflected-wave-suppression opening 4b to vary every moment, where opening 4b is formed at a lower section of the lateral face of heating chamber 1. The variation in the distance causes changes every moment in an amount and a phase of the microwave (reflected wave 9 shown in FIG. 3) that reflects from the inside of heating chamber 1 toward opening 4b.

In waveguide 3, the microwave (traveling wave 9 shown in FIG. 3) traveling from magnetron 2 toward heating chamber 1 is superposed over reflected wave 9 that returns to waveguide 3 via opening 4b, thereby generating standing wave 10. Since the amount and the phase of reflected wave 9 vary every moment as discussed above, a state of standing wave 10 also varies every moment.

As discussed above, rotational excitations in two directions are superposed together with the aid of traveling wave 8 and reflected wave 9, so that a complex electromagnetic field distribution that varies from the circularly polarized wave to the elliptically polarized wave (close to a linearly polarized wave) and vice versa can be generated. Use of this complex electromagnetic field distribution in heating the target object 6 with the microwave allows reducing unevenness in heating.

In this embodiment, circularly-polarized-wave opening 4a shaped like a letter X is described; however, the shape thereof is not limited to this one. As long as opening 4a includes two rectangular slots orthogonally intersecting with each other, it functions well. For instance, opening 4a can be shaped like a letter L or a letter T. Opening 4a also can be shaped like this as disclosed in patent literature 2: two rectangular slots orthogonally intersecting with each other are spaced away at an interval.

### Second Exemplary Embodiment

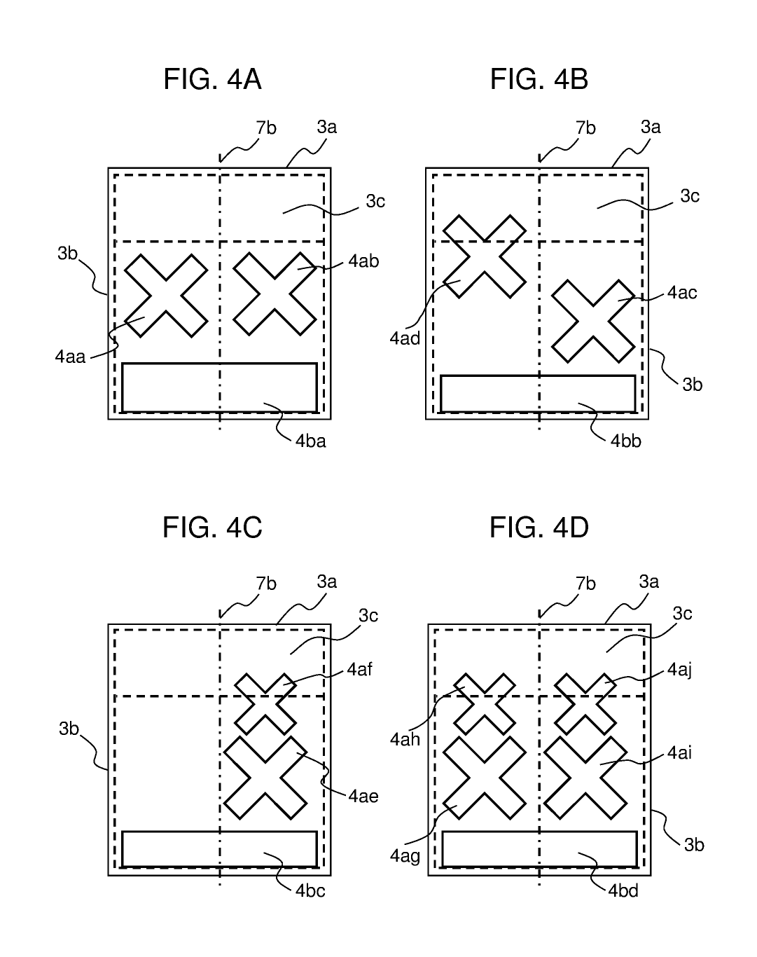

FIG. 4A-FIG. 4D show examples of the opening that allows waveguide 3 to communicate with heating chamber 1 of microwave oven 20 in accordance with the second embodiment of the present disclosure.

As FIG. 4A shows, circularly-polarized-wave openings 4aa, 4ab, and reflected-wave-suppression opening 4ba are formed on a wide plane of parallel section 3b. Openings 4aa and 4ab have the same shape and the same dimensions as opening 4a used in the first embodiment. These two openings 4aa and 4ab are disposed in a lateral direction.

Reflected-wave-suppression opening 4ba is substantially the same as opening 4b used in the first embodiment, and obtains an advantage similar to that of opening 4b.

As FIG. 4B shows, circularly-polarized-wave openings 4ac, 4ad, and reflected-wave-suppression opening 4bb are formed on the wide plane of parallel section 3b. Openings 4ac and 4ad have the same shape and the same dimensions as opening 4a, and these two openings 4ac, 4ad are disposed along a phantom slanting line on the wide plane of parallel section 3b.

Reflected-wave-suppression opening 4bb has a width narrower than that of opening 4b; however, opening 4bb can obtain an advantage similar to that of opening 4b.

As FIG. 4C shows, circularly-polarized-wave openings 4ae, 4af, and reflected-wave-suppression opening 4bc are formed on the wide plane of parallel section 3b. Openings 4ae and 4af have the same shape and the same dimensions as opening 4a, and opening 4af has a shape similar to opening 4a but smaller than opening 4a. Openings 4ae, 4af are disposed along a phantom vertical line on the wide plane at the right-half of parallel section 3b.

Reflected-wave-suppression opening 4bc has a width narrower than that of opening 4b; however, it can obtain an advantage similar to opening 4b.

As FIG. 4D shows, circularly-polarized-wave openings 4ag, 4ah, 4ai, 4aj, and reflected-wave-suppression opening 4bd are formed on the wide plane of parallel section 3b. Openings 4ag and 4ah have the same shape and the same dimensions as openings 4ae and 4af shown in FIG. 4C respectively, and these two openings 4ag and 4ah are disposed on the wide plane at the right-half of parallel section 3b. Openings 4ai and 4aj have the same shape and the same dimensions as openings 4ag and 4ah respectively, and they are disposed on the wide plane at the left-half of parallel section 3b.

Reflected-wave-suppression opening 4bd has a width narrower than opening 4b; however, opening 4bd can obtain an advantage similar to opening 4b.

As FIG. 4A-FIG. 4D show, circularly-polarized-wave openings 4aa-4aj are formed such that each center of openings 4aa-4aj is located outside the projected cross section region 3c and tube axis 7b. This structure is similar to that of opening 4a in accordance with the first embodiment.

The structures discussed above allow generating excitations at the edge of the electromagnetic field having less disturbance. This excitation has a time lag in two directions. As a result, the circularly polarized wave or the elliptically polarized wave can be generated more positively.

### Third Exemplary Embodiment

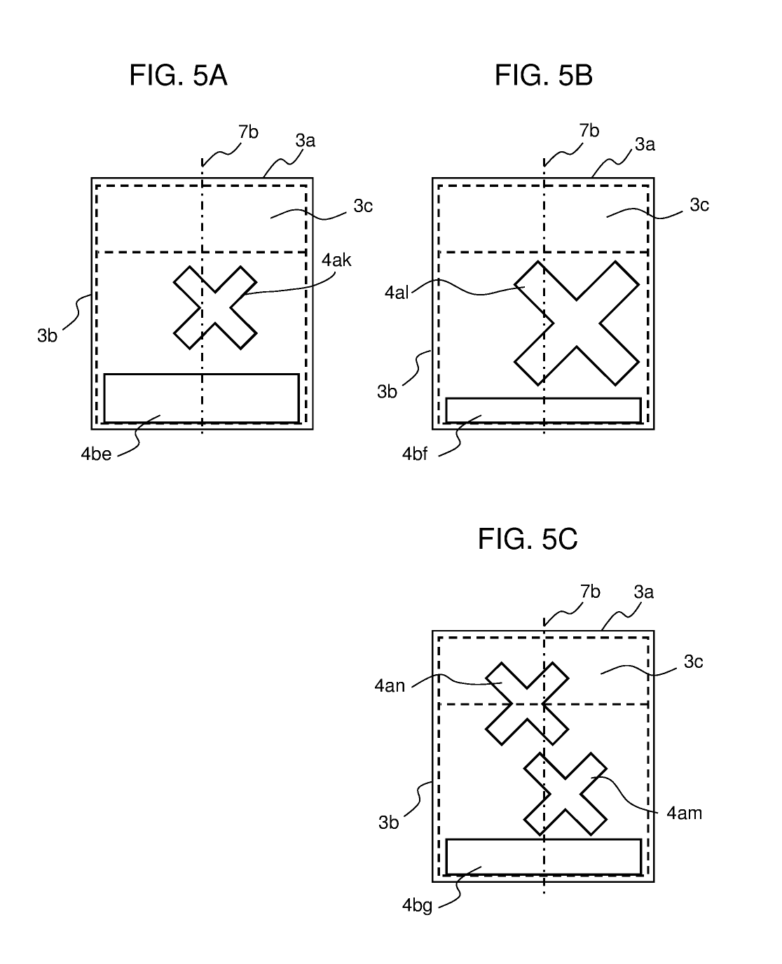

FIG. 5A-FIG. 5C show examples of openings that allow waveguide 3 to communicate with heating chamber 1 of microwave oven 20 in accordance with the third embodiment.

As FIG. 5A shows, circularly-polarized-wave opening 4ak and reflected-wave-suppression opening 4be are formed on the wide plane of parallel section 3b of waveguide 3. Opening 4ak has the same shape and the same dimensions as circularly-polarized-wave opening 4a in accordance with the first embodiment.

Reflected-wave-suppression opening 4be is substantially the same as opening 4b in accordance with the first embodiment, and obtains an advantage similar to that of the first embodiment.

As FIG. 5B shows, circularly-polarized-wave opening 4a1 and reflected-wave-suppression opening 4bf are formed on the wide plane of parallel section 3b of waveguide 3. Opening 4a1 has a shape similar to opening 4a but its dimensions are greater than opening 4a.

Reflected-wave-suppression opening 4bf is smaller than opening 4b, but can obtain an advantage similar to that of opening 4b.

As FIG. 5C shows, circularly-polarized-wave openings 4am, 4an, and reflected-wave-suppression opening 4bg are formed on the wide plane of parallel section 3b. This structure is similar to that shown in FIG. 4B, where circularly-polarized-wave openings 4ac, 4ad, and reflected-wave-suppression opening 4bb are formed. Openings 4am and 4an are disposed closer to tube axis 7b of parallel section 3b than openings 4ac and 4ad shown in FIG. 4B.

As FIG. 5A-FIG. 5C show, circularly-polarized-wave openings 4ak, 4al, 4am, and 4n are placed such that each center of these openings is located outside the projected cross section region 3c and tube axis 7b. This structure is similar to that of opening 4a in accordance with the first embodiment.

The structures discussed above allow generating excitations at the edge of the electromagnetic field having less disturbance. This excitation has a time lag in two directions. As a result, the circularly polarized wave or the elliptically polarized wave can be generated more positively.

### Fourth Exemplary Embodiment

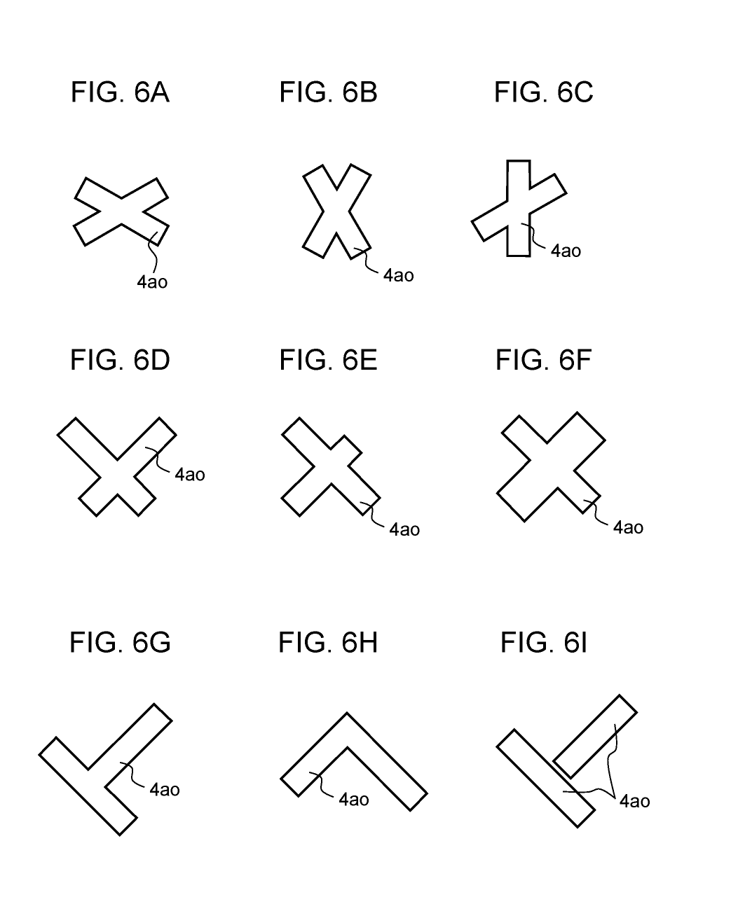

FIG. 6A-FIG. 6I show examples of openings that allow waveguide 3 to communicate with heating chamber 1 of microwave oven 20 in accordance with the fourth embodiment.

As FIG. 6A-FIG. 6F show, circularly-polarized-wave opening 4ao shapes like a cross-slot in which two rectangular slots intersect with each other.

Comparing with circularly-polarized-wave opening 4a used in the first embodiment, circularly-polarized-wave openings 4ao shown in FIG. 6A-FIG. 6F differ, for instance, in the size of rectangular slot, an intersecting angle of the two rectangular slots, and an intersecting position. Nevertheless each of openings 4ao can generate the excitation having a time lag in two directions as opening 4a can. As a result, the structures shown in FIG. 6A-FIG. 6F allow generating the circularly polarized wave or the elliptically polarized wave more positively.

The shape of opening 4ao is not limited to a letter X. As long as opening 4ao includes two rectangular slots orthogonally intersecting with each other, opening 4ao functions well. For instance, circularly-polarized-wave opening 4ao can be shaped like a letter L, or letter T, and as patent literature 2 discloses, opening 4ao can include two rectangular slots orthogonally intersecting with each other and spaced at an interval.

Circularly-polarized-wave opening 4ao shown in FIG. 6G-FIG. 6I is also structured by combining two rectangular slots; however, these two slots do not intersect with each other. This structure still can obtain an advantage similar to openings 4ao shown in FIG. 6-FIG. 6F.

A shape of the rectangular slot is not necessarily limited to a strict rectangle. For instance, the corners of rectangular slot can be elliptical. Here is another instance: a rectangular slot intersects with another rectangular slot having shorter and narrower dimensions at right angles, then an advantage similar to what is discussed previously can be obtained.

Each of the rectangular slots of circularly-polarized-wave opening 4ao is not necessarily limited to a strict rectangle. For instance, the corners of rectangular slot can be elliptical. This is a basic manner in which two rectangular slots intersect with each other at right angles, and one of the two slots has shorter and narrower dimensions than the other slot, and yet that one slot is placed such that its longer side confronts the narrow plane of waveguide 3. The structure following this basic manner can obtain an advantage similar to what is discussed previously.

### Fifth Exemplary Embodiment

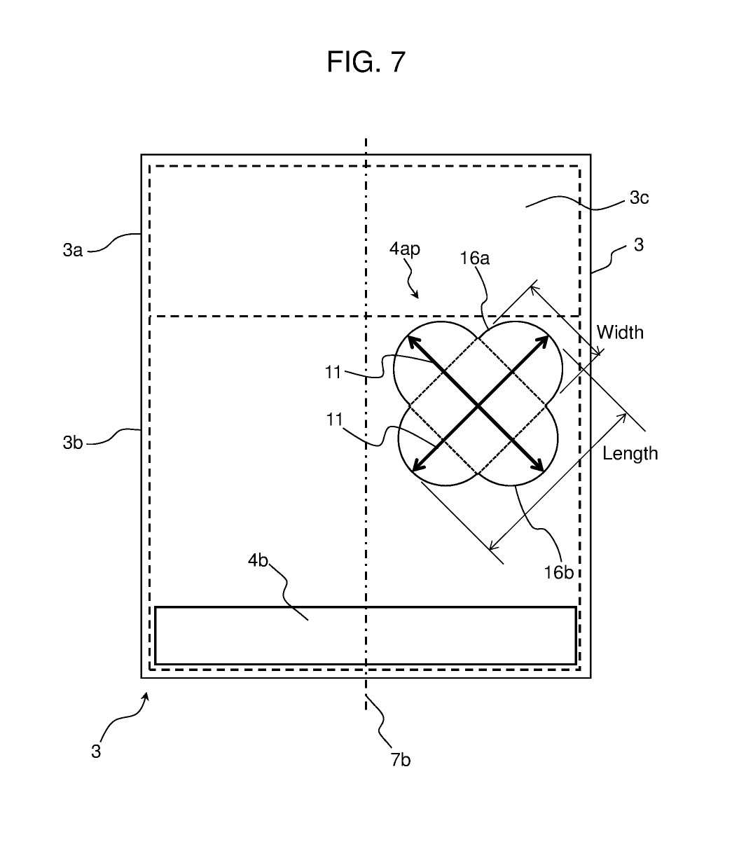

FIG. 7 shows an opening that allows waveguide 3 to communicate with heating chamber 1 of microwave oven 20 in accordance with the fifth embodiment.

As FIG. 7 shows, circularly-polarized-wave opening 4ap is formed on the wade plane of waveguide 3. Opening 4ap shapes like a cross slot in which two slots 16a and 16b intersect orthogonally with each other. The longer sides (length shown in FIG. 7) of these two slots are longer than the shorter sides (width shown in FIG. 7) of these two slots.

Similar to the embodiments discussed previously, opening 4ap is placed such that its center is located outside the cross-section projected region 3c. On top of that, opening 4ap is placed such that its center is located outside tube axis 7b of parallel section 3b of waveguide 3.

An amount of electric power of the microwave radiated from slots 16a and 16b depends on the maximum inner diameter of opening 4ap. An exciting direction of the microwave depends on a direction of the maximum inner diameter.

As FIG. 7 shows, each end of slots 16a, 16b forms a circular arc, the maximum inner diameter 11 is slightly greater than the circularly-polarized-opening having a strictly rectangular slot by a roundness at both the ends. According to this fifth embodiment, the foregoing structure allows supplying, to heating chamber 1, the microwave having a greater amount of electric power than the circularly-polarized openings previously discussed.

The structure discussed above allows generating excitations at the edge of the electromagnetic field having less disturbance. This excitation has a time lag in two directions. As a result, the circularly polarized wave or the elliptically polarized wave can be generated more positively.

In this fifth embodiment, slots 16a and 16b having a circular arc shape at both ends are used. Each of slots 16a and 16b thus forms a track of an athletic field; however, a rectangular slot of which corner is slightly rounded can be used. In other words, each of the two slots has the maximum inner diameter in a longer direction at least at two places. This structure can produce an advantage similar to what is discussed previously.

### Sixth Exemplary Embodiment

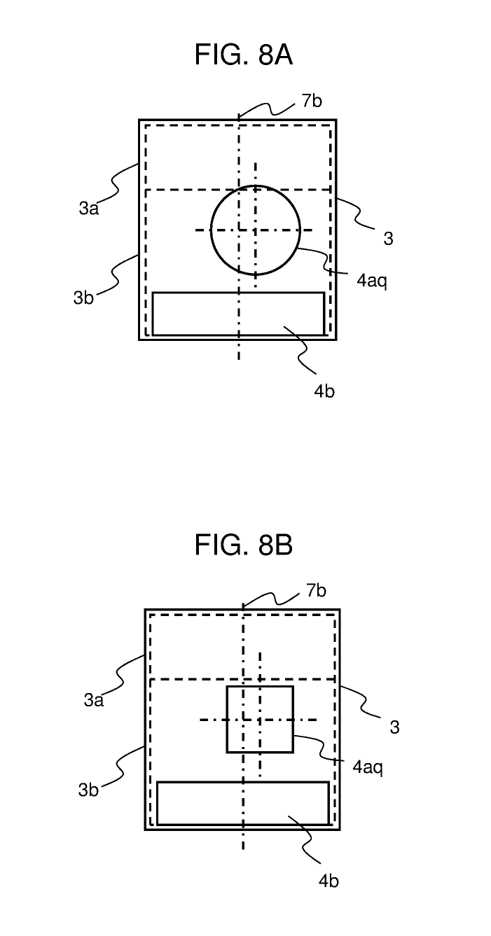

FIG. 8A shows an example of an opening that allows waveguide 3 to communicate with heating chamber 1 of microwave oven 20 in accordance with the sixth embodiment. In this sixth embodiment, circularly-polarized-opening 4aq forms a circular opening.

As FIG. 8A shows, similar to the embodiments discussed previously, opening 4aq is placed such that its center is located outside the cross-section projected region 3c. On top of that, opening 4aq is placed such that its center is located outside tube axis 7b. Use of such single circular opening 4aq allows generating the excitations of microwave in multiple directions uniformly.

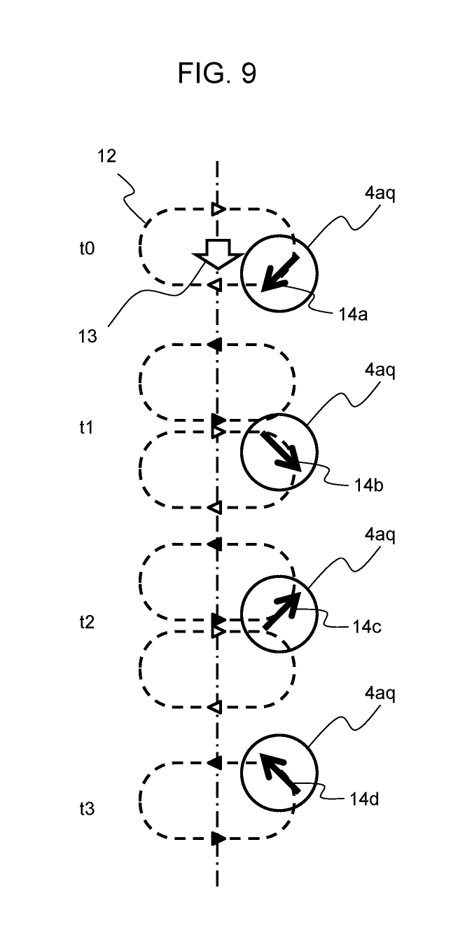

FIG. 9 shows changes in status of generating a circularly polarized wave at opening 4aq in accordance with the sixth embodiment.

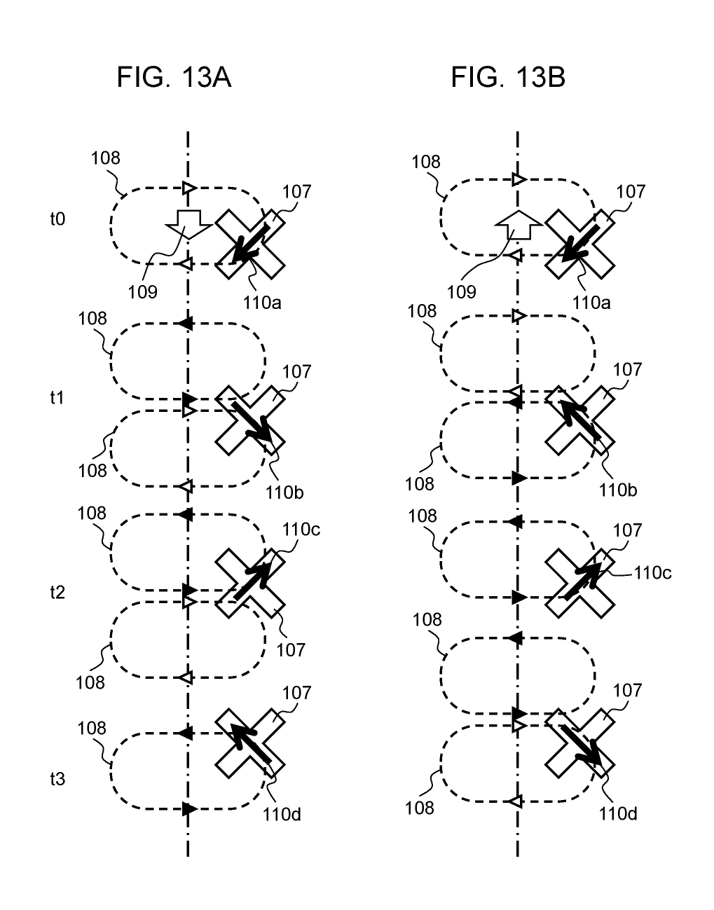

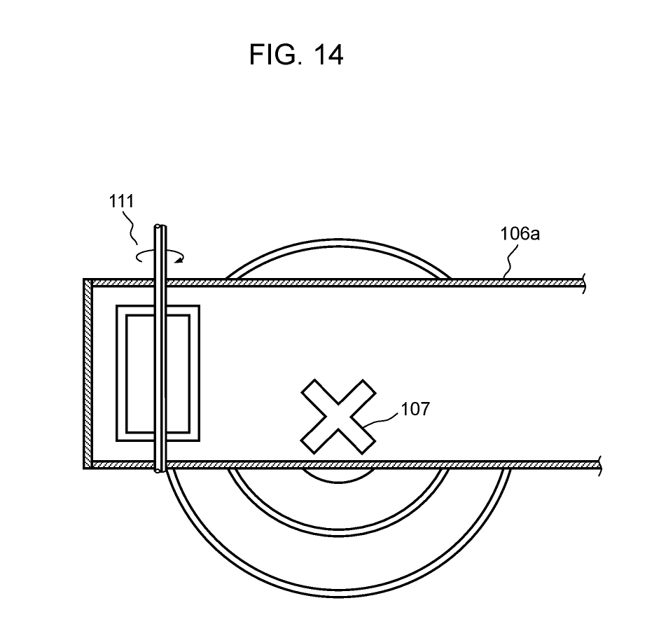

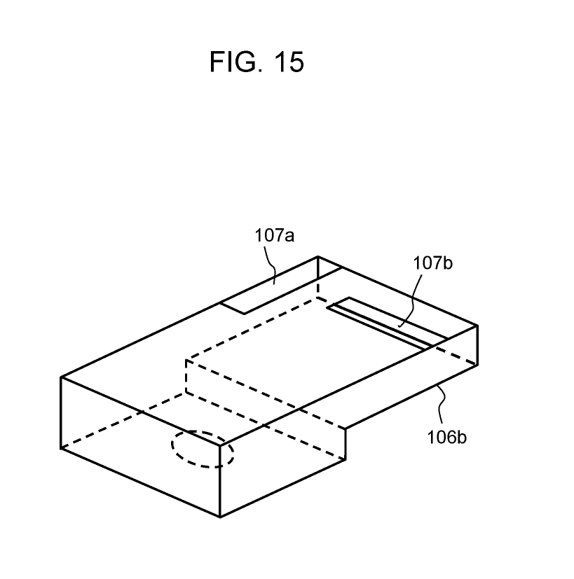

In FIG. 9, similar to what is shown in FIG. 13A, the microwave propagates in downward direction 13 on the paper, and magnetic field 12 moves downward with the lapse of time.

As FIG. 9 shows, at time to, the microwave radiated from circularly-polarized-wave opening 4aq is excited by magnetic field 12 in exciting direction 14a. In a given time from time t0 (i.e. at time t1), magnetic field 12 travels through waveguide 3 (downward in FIG. 9), so that the microwave radiated from opening 4aq is excited in exciting direction 14b.

In a given time from time t1 (i.e. at time t2), the microwave radiated from opening 4aq is excited in exciting direction 14c, and in a given time from time t2 (i.e. at time t3), the microwave radiated from opening 4aq is excited in exciting direction 14d. The circularly polarized wave rotating anticlockwise is thus generated.

As discussed above, the microwave radiated from opening 4aq is excited at the edge of magnetic field 12 in waveguide 3, thereby changing the exciting direction with the lapse of time. The microwave supplied into heating chamber 1 is thus excited in two directions uniformly. As a result, the circularly polarized wave can be generated more positively.

In this sixth embodiment, opening 4aq in circular shape is demonstrated; however, the shape thereof is not limited to a circle. For instance, opening 4aq can form a square as shown in FIG. 8B, or regular polygon such as a regular pentagon or a regular hexagon. These instances can also obtain an advantage similar to what is discussed previously.

### Seventh Exemplary Embodiment

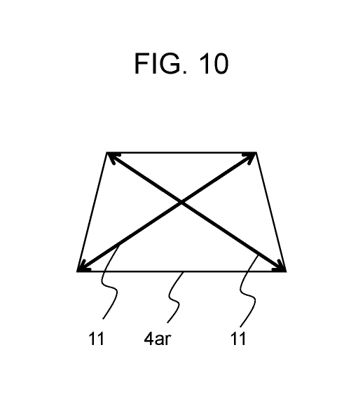

FIG. 10 shows an example of an opening that allows waveguide 3 to communicate with heating chamber 1 of microwave oven 20 in accordance with the seventh embodiment.

As FIG. 10 shows, circularly-polarized-wave opening 4ar shapes like a trapezoid and has the maximum inner diameter at two places (i.e. a length of a diagonal line is maximum inner diameter 11).

The foregoing structure allows generating excitations in two directions different from each other more positively, so that a circularly polarized wave can be generated from opening 4ar.

### Eighth Exemplary Embodiment

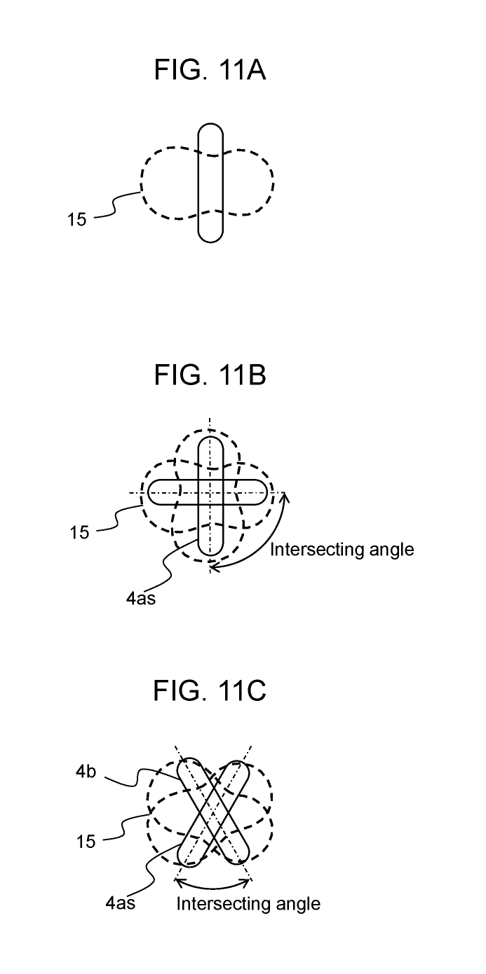

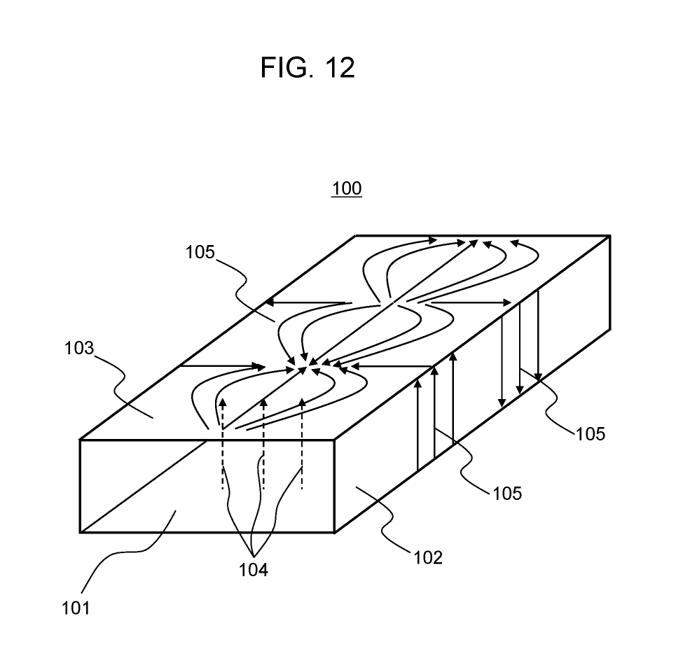

FIG. 11A illustrates a directivity of a slot opening formed in waveguide 3.

As shown in FIG. 11A, the radiation directivity of the microwave radiated from the slot opening shows a distribution spreading in a direction orthogonally intersecting with a longer side of the slot opening. This distribution does not spread uniformly in two directions orthogonally intersecting with the longer side of the slot opening, but it spreads unevenly depending on a position, orientation, and so on of the slot opening formed in the wide plane of waveguide 3.

FIG. 11B and FIG. 11C illustrates an example of a directivity of circularly-polarized-wave opening 4as formed on waveguide 3 in accordance with the eighth embodiment.

As FIG. 11B shows, in the case of opening 4as having a shape of a cross slot (i.e. two slot-openings intersect with each other at right angles), radiation directivity 15 can be distributed such that a strong directivity portion of one slot opening can compensate for a weak directivity portion of the other slot opening. This structure allows opening 4as to radiate the microwave in various directions more uniformly.

As FIG. 11C shows, in the case of opening 4as having a shape of a cross slot (i.e. two slot openings intersect with each other at angles other than 90 degrees), radiation directivity 15 is distributed unevenly. Appropriate selections of an intersecting angle of two slot-openings, and an intersecting angle of each of two slot-openings with tube axis 7b allow adjusting the electromagnetic field distribution with an aid of unevenness in radiation directivity 15 of the microwave.

### INDUSTRIAL APPLICABILITY

The microwave processing apparatus of the present disclosure allows irradiating a target object with a microwave uniformly. The microwave processing apparatus thus can be applicable to microwave heating devices to be used for cooking and sterilization.

### REFERENCE MARKS IN THE DRAWINGS

1 heating chamber
2 magnetron
3, 100, 106a, 106b waveguide
3a vertical section
3b parallel section
3c cross-section projected region
4, 4a, 4aa, 4ab, 4ac, 4ad, 4ae, 4af, 4ag, 4ah, 4ai, 4aj, 4ak, 4al, 4am, 4an, 4ao, 4ap, 4aq, 4ar, 4as circularly-polarized-wave opening
4b, 4ba, 4bb, 4bc, 4bd, 4be, 4bf, 4bg reflected-wave-suppression opening
5 table
6 target object
7a, 7b tube axis
8 traveling wave
9 reflected wave
10 standing wave
11 maximum inner diameter
12, 108 magnetic field
13, 109 propagating direction
14a, 14b, 14c, 14d, 110a, 110b, 110c exciting direction
15 radiation directivity
16a, 16b slot
20 microwave oven

1. A microwave treatment apparatus comprising:
a heating chamber for accommodating a target object;
a microwave generator for generating a microwave; and
a waveguide having an E-bend structure and including a first section for propagating the microwave from the microwave generator toward the heating chamber and a second section of which wide plane abuts on an outer wall of the heating chamber;
wherein the heating chamber has a lateral face provided with a plurality of openings allowing the heating chamber to communicate with the waveguide, and including at least one circularly-polarized-wave opening for generating a circularly polarized wave, and
the circularly-polarized-wave opening is formed such that a cross section of the first section intersecting orthogonally with a tube axis of the first section is virtually projected along the tube axis of the first section onto the lateral face of the heating chamber, and a center of the circularly-polarized-wave opening is located outside a resultant cross-section-projected region defined by the projection.

2. The microwave treatment apparatus according to claim 1 further comprising a reflected-wave-suppression opening formed closer to an end of the waveguide than the circularly-polarized-wave opening is, and having a length equal to or greater than a half of a wavelength of the microwave.

3. The microwave treatment apparatus according to claim 2 further comprising a table provided to a lower section of the heating chamber for the target object to be placed on, and a driver for rotating the table,
wherein the reflected-wave-suppression opening is formed at the lower section of the heating chamber.

4. The microwave treatment apparatus according to claim 1, wherein two slot-openings are combined for forming the circularly-polarized-wave opening.

5. The microwave treatment apparatus according to claim 1, wherein the circularly-polarized-wave opening is formed such that the center of the circularly-polarized-wave opening is located off a tube axis of the second section.

6. The microwave treatment apparatus according to claim 1, wherein the circularly-polarized-wave opening has a shape of a regular polygon or a circle.

7. The microwave treatment apparatus according to claim 1, wherein the circularly-polarized-wave opening forms a polygonal opening having a shape of a polygon, and the polygonal opening has a plurality of longest diagonal lines.

8. The microwave treatment apparatus according to claim 4, wherein the two slot-openings have a longer side of which length is different from a length of a shorter side of the two slot-openings, and have rounded corners, and wherein the circularly-polarized-wave opening has a plurality of longest inner diameters.

9. The microwave treatment apparatus according to claim 4, wherein the circularly-polarized-wave opening is formed such that the two slot-openings intersect with each other at an angle other than 90 degrees.

10. The microwave treatment apparatus according to claim 4, wherein the circularly-polarized-wave opening is formed such that one of the two slot-openings intersects with a tube axis of the second section at a first angle, and another one of the two slot-openings intersects with the tube axis of the second section at a second angle different from the first angle.
